(19) United States
(12) Patent Application Publication
(10) Pub. No.: US 2010/0208296 A1
(43) Pub. Date: Aug. 19, 2010

(54) IMAGE PROCESSING APPARATUS AND CONTROL METHOD THEREFOR, SERVER APPARATUS AND CONTROL METHOD THEREFOR, AND STORAGE MEDIUM

(75) Inventor: Atsushi Kamasuka, Matsudo-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/703,370

(22) Filed: Feb. 10, 2010

(30) Foreign Application Priority Data
Feb. 18, 2009 (JP) 2009-035400

(51) Int. Cl. G06F 3/12; G06F 15/16; G06F 3/048

(52) U.S. Cl. 358/1.15; 709/203; 715/764

(57) ABSTRACT

An image processing apparatus enabling to simplify operations for exchange and setting of configuration information between an apparatus directed to a user and external apparatus. A request unit requests the external apparatus to output information stored in the external apparatus. A determination unit determines whether or not information to be output from the external apparatus is information that can be set as configuration information for the image processing apparatus, based on a response from the external apparatus to the request from the request unit. A presentation unit presents a user with a setup ordering button for the user to order setting of information output from the external apparatus as configuration information for the image processing apparatus if the determination unit determines that the information to be output from the external apparatus is information that can be set as configuration information for the image processing apparatus.

### BACKGROUND OF THE INVENTION

1. Field of the Invention

The present invention relates to an image processing apparatus that can be connected with an external apparatus via a network and a control method therefor, a server apparatus that can be connected with a client apparatus via a network and a control method therefor, and a computer-readable storage medium for storing programs for realizing the control methods.

2. Description of the Related Art

Remote user interfaces are known also in the field of image processing apparatuses such as copiers that allow an apparatus to have web server functions in addition to its primary functions and provide a user interface for the apparatus to a remote web browser.

A user of such an image processing apparatus with a web server and/or a web browser installed therein can access a web server installed in another image processing apparatus from the browser of his own apparatus and realize such functions as follows through operation of his apparatus: browsing and/or registration of status or configuration information of the other apparatus, upload of images, retrieval/loading of various configuration information of the other apparatus as a file and so forth, for example.

Techniques for realizing image upload include a technique disclosed by Japanese Laid-Open Patent Publication (Kokai) No. 2005-149320, for instance. According to the technique of Japanese Laid-Open Patent Publication (Kokai) No. 2005-149320, an image processing apparatus retrieves an HTML document from a server and displays a “Send” button on its operation section based on the HTML document. When the “Send” button is then pressed by the user, an image of an original is scanned by a scanner included in the image processing apparatus and the resulting image data is uploaded to the server.

Another example of techniques for realizing a function of loading configuration information of another apparatus as a file is a technique as follows: A user accesses a web server of another image processing apparatus from a web browser of his own image processing apparatus and downloads device information of the other apparatus to his apparatus as a file. FIG. 14 shows a screen with an example dialogue that is displayed when a file has been downloaded from a web server, and an example of a save dialogue displayed on a general web browser.

This dialogue is displayed based on a response from the web server. The user presses Save button 11 in the dialogue to display the dialogue shown in FIG. 15 and saves the file in a desired directory specified in the dialogue.

As outlined above, a conventional image processing apparatus allows the user to control browsing and/or setting of another apparatus's status and/or configuration information from his own apparatus by accessing a web server included in the other image processing apparatus from the browser of the user's apparatus.

To load configuration information of another apparatus to the user's own apparatus and set the information as configuration information of the user's apparatus, however, it is necessary to retrieve and prepare configuration information of the other apparatus in advance, that is to say, to obtain the configuration information from the other apparatus beforehand and store the information as a file in a storage section, such as an HDD. The user then has to make another access to the web server of the image processing apparatus itself to which the device information will be stored. Thus, although a conventional apparatus permits the user to operate another apparatus from his own apparatus through a web browser, it involves complicated operations to exchange device information.

### SUMMARY OF THE INVENTION

The present invention provides an image processing apparatus and a control method therefor, a server apparatus and a control method therefor, and a computer-readable storage medium for storing programs for realizing the control methods.

Accordingly, in a first aspect of the present invention, there is provided an image processing apparatus that performs communication with an external apparatus connected via a network based on a predetermined communication protocol, the image processing apparatus comprising a request unit adapted to request the external apparatus to output information stored in the external apparatus, a determination unit adapted to determine whether or not information to be output from the external apparatus is information that can be set as configuration information for the image processing apparatus, based on a response from the external apparatus to the request from the request unit, and a presentation unit adapted to present a user with a setup ordering button for the user to order setting of information output from the external apparatus as configuration information for the image processing apparatus if the determination unit determines that the information to be output from the external apparatus is information that can be set as configuration information for the image processing apparatus.

Accordingly, in a second aspect of the present invention, there is provided a server apparatus that performs communication with a client apparatus connected via a network based on a predetermined communication protocol, the server apparatus comprising an acceptance unit adapted to accept an output request for information stored in the server apparatus from the client apparatus, a determination unit adapted to, if the acceptance unit accepts the output request for information, determine whether or not a client apparatus that made the output request is a particular client apparatus, and a transmission unit adapted to transmit, to the client apparatus, screen information for displaying an operation screen including a setup ordering button for a user to order setting of information output by the server apparatus as configuration information for the client apparatus on a display section of the client apparatus if the determination unit determines that the client apparatus that made the output request is a particular client apparatus.

Accordingly, in a third aspect of the present invention, there is provided a control method for an image processing apparatus that performs communication with an external apparatus connected via a network based on a predetermined communication protocol, the method comprising a request step of requesting the external apparatus to output information stored in the external apparatus, a determination step of determining whether or not information to be output from the external apparatus is information that can be set as configuration information for the image processing apparatus, based on a response from the external apparatus to the request made in the request step, and a presentation step of presenting a user with a setup ordering button for the user to order setting of information output from the external apparatus as configuration information for the image processing apparatus if the determination step determines that the information to be output from the external apparatus is information that can be set as configuration information for the image processing apparatus.

Accordingly, in a fourth aspect of the present invention, there is provided a control method for a server apparatus that performs communication with a client apparatus connected via a network based on a predetermined communication protocol, the method comprising an acceptance step of accepting an output request for information stored in the server apparatus from the client apparatus, a determination step of, if the output request for information is accepted in the acceptance step, determining whether or not a client apparatus that made the output request is a particular client apparatus, and a transmission step of transmitting, to the client apparatus, screen information for displaying an operation screen including a setup ordering button for a user to order setting of information output by the server apparatus as configuration information for the client apparatus on a display section of the client apparatus if the determination step determines that the client apparatus that made the output request is a particular client apparatus.

Accordingly, in a fifth aspect of the present invention, there is provided a computer-readable storage medium for storing a program for causing a computer to implement a control method for an image processing apparatus.

Accordingly, in a sixth aspect of the present invention, there is provided a computer-readable storage medium for storing a program for causing a computer to implement a control method for a server.

According to the present invention, it is not necessary to retrieve and prepare configuration information in advance when loading configuration information of another apparatus to his own apparatus via the network, thus simplifying operations for exchange and setting of configuration information between apparatuses to improve the user's convenience.

Further features of the present invention will become apparent from the following description of exemplary embodiments (with reference to the attached drawings).

### BRIEF DESCRIPTION OF THE DRAWINGS

FIG. 1 is a block diagram schematically showing an overall configuration of a system that includes an image processing apparatus.

FIG. 2 is a block diagram schematically showing a software configuration of the image processing apparatus of FIG. 1.

FIG. 3 is a block diagram schematically showing a detailed configuration of the image processing apparatus of FIG. 1.

FIG. 4 is a block diagram schematically showing a detailed configuration of an operation section in FIG. 1.

FIG. 5 is a diagram schematically showing a screen layout of a web browser displayed by a UI module.

FIG. 6 is a sequence chart showing a flow of processing HTTP-protocol requests and responses in a first embodiment of the present invention.

FIG. 7 is a flowchart showing a flow of processing performed by the image processing apparatus according to the present embodiment of the present invention.

FIG. 8 is a screen view showing a display characteristic to the present embodiment.

FIG. 9 is an diagram showing an example of a dialogue that is displayed in accordance with a device information loading process.

FIG. 10 is an diagram showing a system management/setting screen according to the present embodiment.

FIG. 11 is a flowchart showing a flow of processing for importing device information

FIG. 12 is an diagram showing an example of a dialogue that is displayed for specifying a saving location.

FIG. 13 is a flowchart showing operations according to a second embodiment of the present invention.

FIG. 14 is a screen view showing an example dialogue that is displayed when a file has been downloaded.

FIG. 15 is a screen view showing an example dialogue used for file saving.

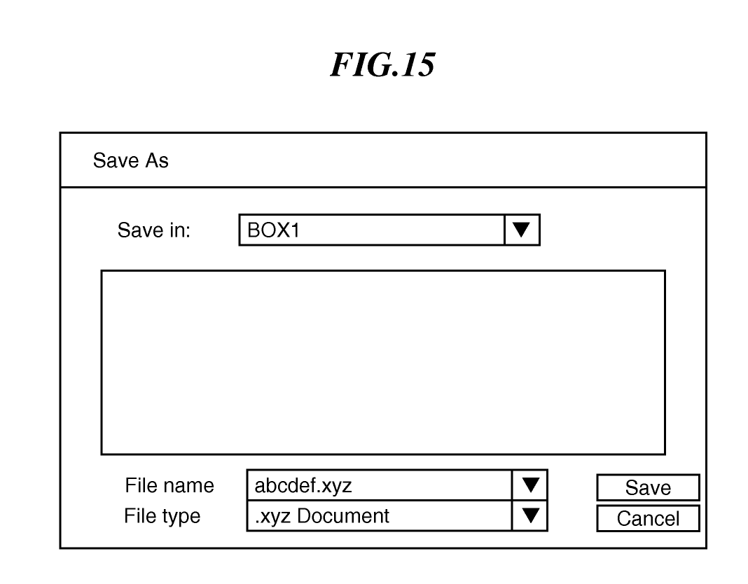

### DESCRIPTION OF THE EMBODIMENTS

Embodiments of the present invention will be now described with reference to the drawings.

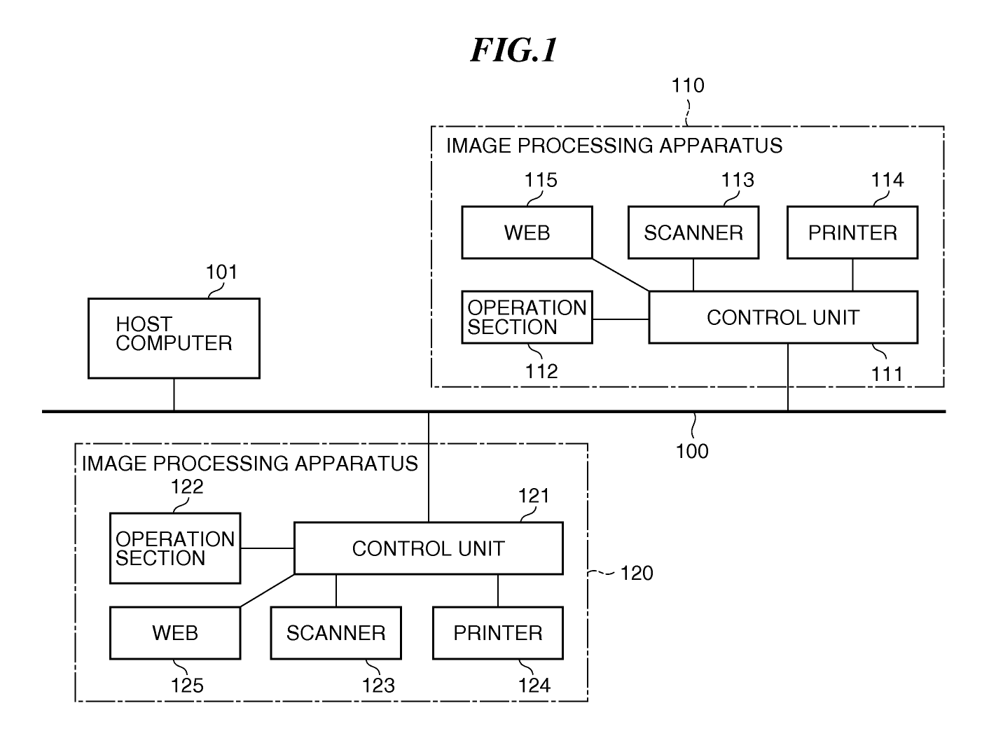

FIG. 1 is a block diagram schematically showing an overall configuration of a system that includes an image processing apparatus according to a first embodiment of the present invention.

An image processing apparatus 110 is a Multi Function Peripheral (MFP) that performs input/output and transmission/reception of images as well as various types of image processing. The image processing apparatus 110 includes a scanner 113 as an image input device, a printer 114 as an image output device, a control unit 111, and an operation section 112 as a user interface. The image processing apparatus 110 also has a web browser/web server module 115 as described below. These components are each connected with the control unit 111 and controlled in accordance with instructions from the control unit 111. The control unit 111 is connected to a LAN 100.

An image processing apparatus 120 has a similar configuration to that of the image processing apparatus 110 and the components of the apparatus 120 are also connected to the LAN 100. The image processing apparatus 120 has a scanner 123, a printer 124, a operation section 122, a web module 125, and a control unit 121 for controlling the components.

A host computer 101 (an external apparatus) is connected to the LAN 100. The host computer 101 has a web browser as mentioned later, and displays status or the like of the image processing apparatuses 110 and 120 based on HTML files received from the image processing apparatuses 110 and 120.

It should be noted that description of the present embodiment assumes that an access is made from the web browser of the image processing apparatus 110 to the web server of the image processing apparatus 120, and device information of the image processing apparatus 120 is uploaded to the image processing apparatus 110.

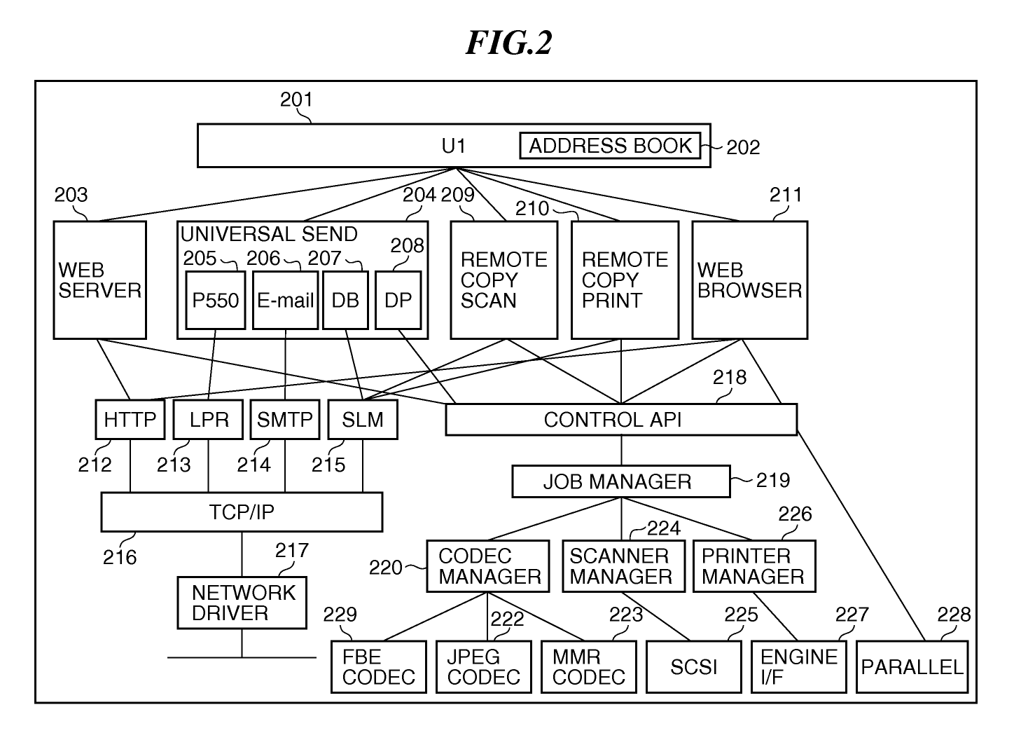

Next, software configuration of the image processing apparatus 110 is described with reference to FIG. 2. FIG. 2 is a block diagram schematically showing the software configuration of the image processing apparatus 110 of FIG. 1. As the image processing apparatuses 110 and 120 have the same software configuration, the software configuration of the image processing apparatus 110 is described here.

The image processing apparatus 110 includes a user interface (hereinafter “UI”) module 201. The UI module 201 intervenes between the image processing apparatus 110 and user operations when an operator performs various operations or settings for the image processing apparatus 110. The UI module 201 requests processing and/or sets data by transferring input information to various modules described below in accordance with the operator's operations.

The image processing apparatus 110 also has an Address-Book module 202, which is a database module for managing destinations of data transmission, communication and the like. Data managed by the Address-Book module 202 can be added, deleted, and retrieved through operations from the UI module 201. The Address-Book module 202 also supplies information on a destination of data transmission or communication to the various modules described below in accordance with the operator's operations.

The image processing apparatus 110 also includes a Web-Server module 203. The Web-Server module 203 provides management information of the image processing apparatus 110 to a web client (e.g., the host computer 101) in response to a request from the web client. The management information is obtained by way of the following modules: a Universal-Send module 204, a Remote-Copy-Scan module 209, a Remote-Copy-Print module 210, and a Control API module 218. The management information is then provided to the web client via an HTTP module 212, a TCP/IP communication module 216, and a network driver 217.

The image processing apparatus 110 also includes a Web Browser module 211, which loads and displays information from various web sites (or web pages) on the Internet or an intranet. A detailed configuration of the web browser module 211 will be shown later.

The Universal-Send module 204 is responsible for data delivery, distributing data specified by the operator via the UI module 201 to a destination of communication (or output) specified in a similar manner. Also, when the operator orders generation of data for distribution using the scanner function of the apparatus, the Universal-Send module 204 has the apparatus operate via the control API module 218 to generate data.

The Universal-Send module 204 includes a module (P550) 205, a module (E-mail) 206, a module (DB) 207, and a module (DP) 208. The module (P550) 205 is executed when the printer is specified as a destination of output, and the module (E-mail) 206 is executed when an e-mail address is specified as a destination of communication. The module (DB) 207 is executed when a database is specified as a destination of output, and the module (DP) 208 is executed when an image processing apparatus similar to the present apparatus is specified as a destination of output.

The Remote-Copy-Scan module 209 reads image information using the scanner function of the image processing apparatus 110 and outputs the image information to another image processing apparatus connected by a network or the like. This enables copy functions realized by an image processing apparatus alone to be achieved using another image processing apparatus.

The Remote-Copy-Print module 210 uses the printer function of the image processing apparatus 110 to output the image information obtained on another image processing apparatus connected via a network or the like. This enables copy functions realized by an image processing apparatus alone to be achieved using another image processing apparatus.

The HTTP module 212 is used when the image processing apparatus 110 performs HTTP communication, providing communication functions to the web-server module 203 and/or the web browser module 211 by using the TCP/IP communication module 216 discussed below. The HTTP module 212 supports a variety of protocols used on the Web, including HTTP, and especially provides communication functions based on a predetermined security-enabled communication protocol.

The image processing apparatus 110 also includes an lpr module 213. The lpr module 213 uses the TCP/IP module 216 discussed below to provide communication functions to the P550 module 205 in the Universal-Send module 204.

The image processing apparatus 110 also includes an SMTP module 214. The SMTP module 214 uses the TCP/IP communication module 216 discussed below to provide communication functions to the E-mail module 206 in the Universal-Send module 204.

The image processing apparatus 110 also includes a Salutation-Manager (SLM) module 215. The SLM module 215 uses the TCP/IP communication module 216 to provide communication functions to the modules 207 and 208, the Remote-Copy-Scan module 209, and the Remote-Copy-Print module 210.

The TCP/IP communication module 216 provides network communication functions to the aforementioned modules using the network driver 217. The network driver 217 controls a portion that is physically connected to the network.

The control API 218 provides upstream modules like the Universal-Send module 204 with an interface with downstream modules like a job manager module 219 which is described later. It can reduce dependencies among upstream and downstream modules and can increase the recyclability of the modules.

The Job Manager module 219 interprets various kinds of processing ordered via the control API 218 by the above-described modules and gives instructions to modules 220, 224 and 226, which are described later. The Job Manager module 219 also centrally manages hardware-related processing carried out in the image processing apparatus 110.

The module 220 is a CODEC Manager module for managing and controlling various types of data compression and decompression in the course of processing specified by the job manager module 219.

The image processing apparatus 110 also includes an FBE encoder module 221. The FBE module 221 compresses data read in a scanning process executed by the job manager module 219 and/or a scan manager module 224, which is described below, using FBE format.

The image processing apparatus 110 also includes a JPEG CODEC module 222. The JPEG module 222 is used for a scanning process executed by the job manager module 219 and/or the scan manager module 224, or a printing process executed by the print manager module 226. Specifically, the JPEG module 222 performs JPEG compression of the scanned data and JPEG decompression of printing data in such a scanning or printing process.

The image processing apparatus 110 also includes an MMR CODEC module 223. The MMR module 223 is used for a scanning process executed by the job manager module 219 and/or the scan manager module 224, or a printing process executed by the print manager module 226. Specifically, the MMR module 223 performs MMR compression of scanned data and MMR decompression of printing data in such a scan or printing process.

The Scan Manager module 224 manages and controls a scanning process ordered by the job manager module 219. Communication between the Scan Manager module 224 and the scanner 113 internally connected with the image processing apparatus 110 is performed via a SCSI driver 225.

The Print Manager module 226 manages and controls a printing process ordered by the job manager module 219. An interface between the print manager module 226 and the printer 114 is provided by an engine interface module 227.

The image processing apparatus 110 also includes a parallel port driver 228, which provides an I/F for outputting data to an output device not shown via a parallel port.

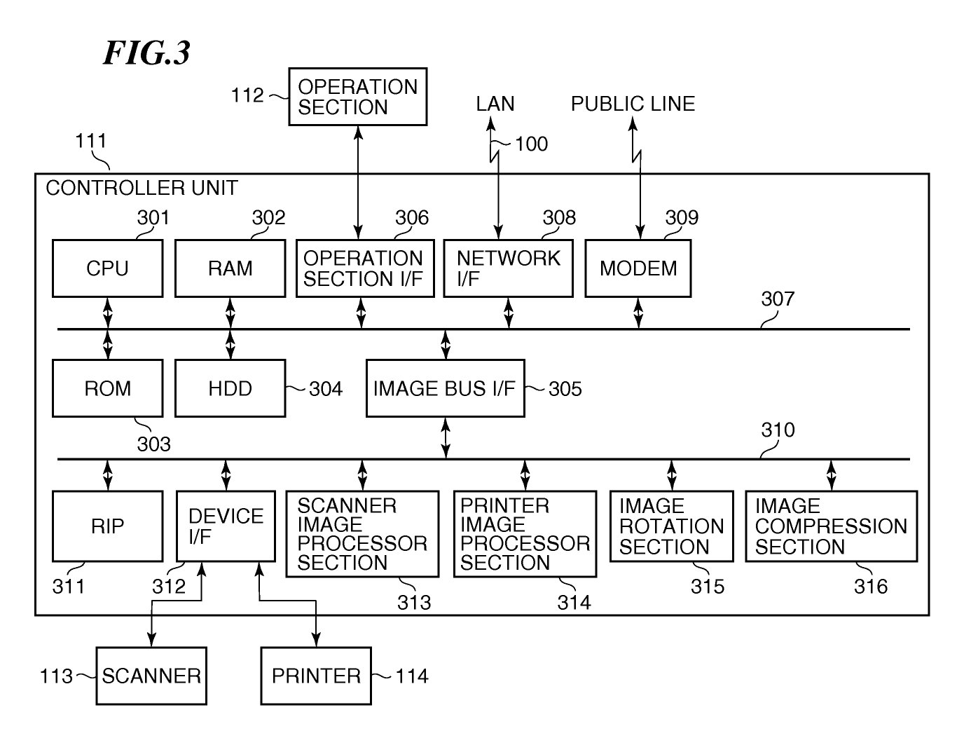

The configuration of the image processing apparatus 110 will be now described with reference to FIG. 3.

FIG. 3 is a block diagram schematically showing a detailed configuration of the image processing apparatus 110 of FIG. 1. As the image processing apparatuses 110 and 120 have the same configuration, the configuration of the image processing apparatus 110 is described here.

The image processing apparatus 110 has the control unit 111 for controlling the entire apparatus as shown in FIG. 3. The control unit 111 is connected with and controls the scanner 113 as an image input device and/or the printer 114 as an image output device, and is also connected with the LAN 100 and/or a public line for input and output of image or device information via the network/line.

The control unit 111 has a CPU 301. The CPU 301 is connected with a RAM 302, a ROM 303, a HDD (hard disk device) 304, an image bus I/F 305, an operation section I/F 306, a network I/F 308, and a modem 309, via a system bus 307.

The RAM 302 is the memory for providing a work area for the CPU 301 and is also used as image memory for temporarily storing image data. The ROM 303 is boot ROM, in which a boot program of the system is stored. In the HDD 304, system software, image data and the like will be stored.

The operation section I/F 306 is an input/output interface with the operation section 112, outputting image data for display on the operation section 112 to the same and sending information entered by the user via the operation section 112 to the CPU 301.

The network I/F 308 is connected with the LAN for information input and output from/to the LAN. The modem 309 is connected with a public line for information input and output from/to the public line.

The image bus I/F 305 is a bus bridge which connects the system bus 307 with an image bus 310 on which image data is transferred at a high speed, and converts data structure therebetween.

To the image bus 310, a Raster Image Processor (RIP) 311, a device I/F 312, a scanner image processing section 313, a printer image processing section 314, an image rotation section 315, and an image compression section 316 are connected.

The RIP 311 translates a PDL code received from the LAN into a bitmap image. The device I/F 312 connects the scanner 113 and the printer 114 with the control unit 111 and performs synchronized/non-synchronized conversion of image data. The scanner image processing section 313 performs correction, processing, editing or the like on the input image data. The printer image processing section 314 performs correction, resolution conversion and the like on image data to be printed out.

The image rotation section 315 performs rotation of image data. The image compression section 316 performs the JPEG compression/decompression process on multivalued image data, and JBIG, MMR, or MH compression/decompression process on binary image data.

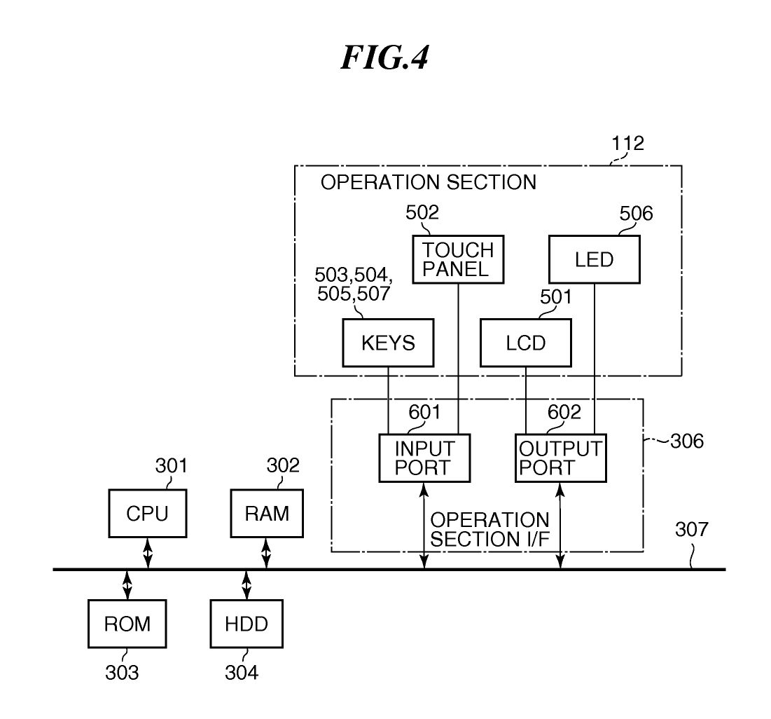

Next, the configuration of the operation section 112 will be described with reference to FIG. 4.

FIG. 4 is a block diagram schematically showing a detailed configuration of the operation section 112 of FIG. 1.

The operation section 112 is connected with the system bus 307 via the operation section I/F 306 as shown in FIG. 4. The CPU 301, the RAM 302, the ROM 303, the HDD 304 and the like are connected to the system bus 307 as mentioned above.

The operation section I/F 306 has an input port 601 for controlling input from the user and an output port 602 for controlling a screen output device. The input port 601 passes user inputs from a touch panel 502 and keys including various hardware keys 503, 504, 505, and 507 to the CPU 301. The CPU 301 generates display screen data based on contents of user inputs and a control program, and outputs the display screen to an LCD display section 501 via the output port 602. The CPU 301 also controls an LED display section 506 as necessary via the output port 602.

Box function is described next. The HDD 304 has a temporary area and a box area. The temporary area is an area for temporarily storing image data scanned by a reader and/or device information to be transmitted, and such data is deleted after a corresponding job terminates. The box area is an area for storing an image scanned by a reader, image data resulting from translation of a PDL image sent from a computer, device information, or the like in accordance with the user's instruction. The box area is divided into multiple areas. Each one of the areas is assigned a number that can identify the area. The present embodiment assumes that the number of boxes is 100.

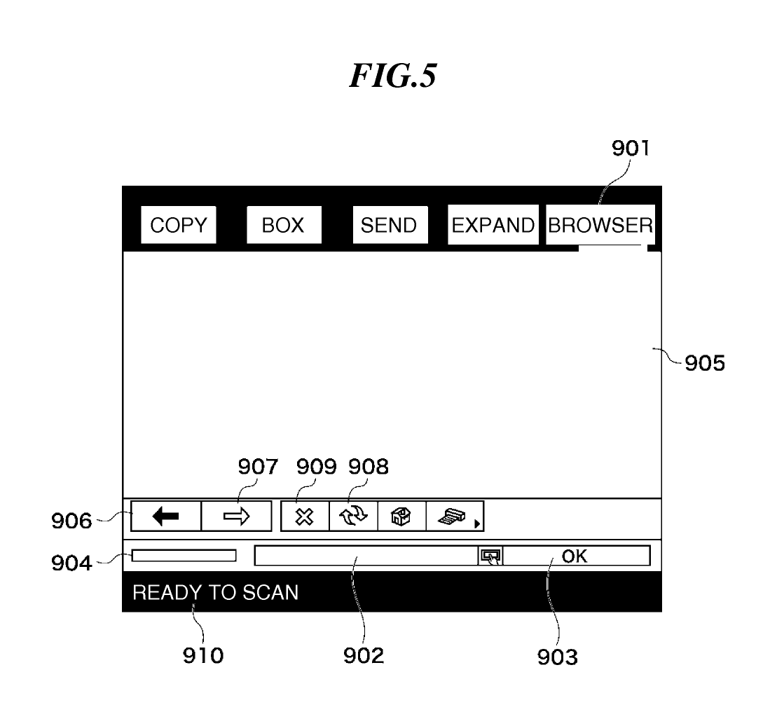

Next, a screen layout of a web browser displayed on the LCD 501 by the UI module 201 will be described with reference to FIG. 5.

FIG. 5 schematically shows a screen layout of a web browser displayed on the LCD 501 by the UI module 201.

On the screen of FIG. 5, tabs 901, a URL entry field 902, an OK button 903, a progress bar 904, and a content display area 905 are displayed. Furthermore, a Back button 906, a Forward button 907, a Reload button 908, a Stop button 909, and a status area 910 are also displayed.

The tabs 901 are for switching screen between web browser function and other functions (copy, box, send, and expand). The URL entry field 902 is a field into which the user enters a URL of a desired resource, and when the user presses the field, a virtual full keyboard for character entry (not shown) appears. The user can enter a desired character string from soft keys arranged on the virtual full keyboard that represent key tops.

The OK button 903 is a soft key for confirming a URL character string entered. When the URL is confirmed, the web browser module 211 issues an HTTP request for retrieving the target resource. The progress bar 904 indicates how far a content retrieval process with HTTP requests and responses has progressed.

The content display area 905 is an area in which the retrieved resource is displayed. The Back button 906 is a soft key for going back through the history of content display and re-displaying a content that was being displayed before the currently displayed content. The Forward button 907 is a soft key for bringing the user back to the display of a content that was once displayed after the previous display of the currently displayed content while the user display contents going back through history. The Reload button 908 is a soft key for re-retrieving and re-displaying the currently displayed content. The Stop button 909 is a soft key for quitting a content retrieval process now in progress.

The status area 910 is an area in which a message from any of various functions of the image processing apparatus is displayed. In the status area 910, a message for calling the user's attention can be displayed from the scanner 113, the printer 114 or other functions even while a web browser screen is displayed. A message can also be displayed from the web browser function. The web browser function can display a URL character string for a linked-page, a character string of a content title, a message specified by a script, or the like.

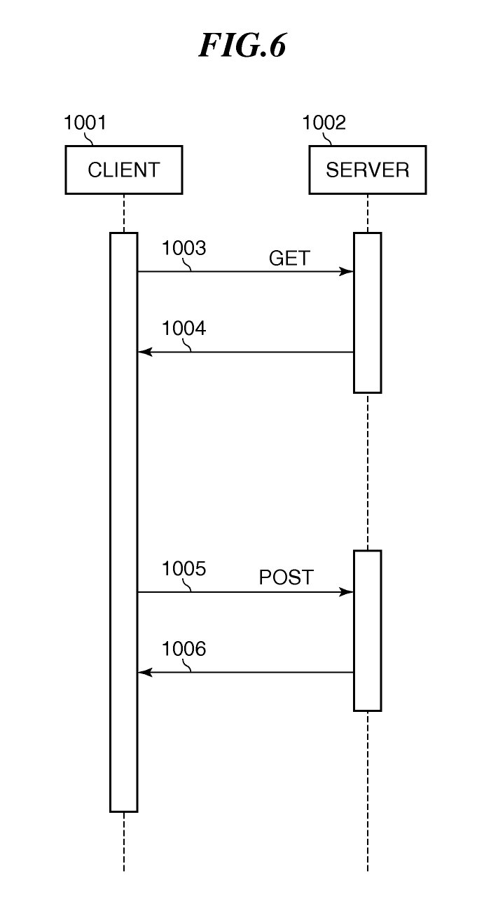

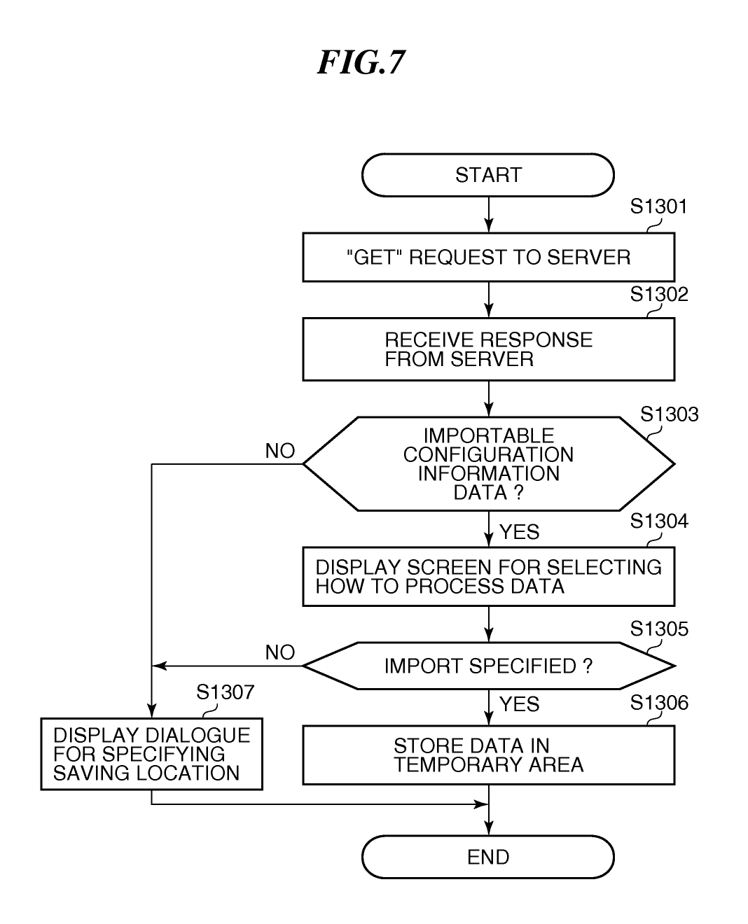

Next, operation of the present embodiment is described with reference to FIGS. 6, 7 and so forth.

(A) Flow of Processing HTTP-Protocol Requests and Responses

FIG. 6 is a sequence chart showing the flow of processing HTTP-protocol requests and responses in the present embodiment.

A client 1001 is software that transmits HTTP requests to a server 1002 and receives HTTP responses from the server 1002 as shown in FIG. 6, corresponding to the web browser included in the image processing apparatus 110 of the present embodiment or a general web browser that runs on a Personal Computer (PC), a Personal Digital Assistant (PDA), or a mobile phone. The client 1001 may also be any of various types of software that accesses a web server in a similar manner to an access to a web browser and utilizes or relays a service. The server 1002 is software that receives an HTTP request from the client 1001 to perform a corresponding process and also returns an HTTP response to the client 1001, corresponding to an HTTP server that contains software running on the web server included in the image processing apparatus 120 of the present embodiment.

The client 1001 can transmit HTTP requests 1003 and 1005 by either GET or POST method. When the client 1001 sends the HTTP request 1003 for a desired resource by GET method to the server 1002, the resource is typically specified in the form of a URI (a URL in particular).

The server 1002 retrieves or generates data corresponding to the resource specified in the HTTP request 1003, and sends back the data to the client 1001 in an HTTP response 1004. If the specified resource corresponds to a static file, the server 1002 reads the file from a file system of the server 1002, for example, to obtain the data.

On the other hand, if the specified resource corresponds to processes of a CGI program or a Servlet, the server 1002 carries out a corresponding process. This processing is for generating a response for the request, but this process involves such side effects as execution of a business logic necessary for achieving a certain service or an access to a backend DBMS. Then, data resulting from the processing is sent back to the client 1001. For example, if a resource for obtaining configuration/registration information for the image processing apparatus is specified, software for retrieving configuration/registration information is executed.

Then, the software carries out a process of referencing records of destination information or management information among pieces of device information or configuration information for other functions, and formatting the information into XML format or other particular format to generate data.

(B) Flow of Process by the Image Processing Apparatus 110

FIG. 7 is a flowchart showing the flow of process performed by the image processing apparatus 110 including the exchanges described above in FIG. 6.

First, in step S1301, the CPU 301 of the image processing apparatus 110 makes an HTTP request in a transmission scheme that is specified in “method” attribute in a target object. Herein, GET transmission is specified as transmission scheme, i.e., this can request output of information stored in the image processing apparatus 120. Then, in step S1302, the CPU 301 receives a response to the HTTP request, that is, the HTTP response (1004 in FIG. 6) from the web server of the image processing apparatus 120.

In step S1303, the CPU 301 checks if body data to be output from the web server is configuration information data that can be imported to the image processing apparatus 110. In other words, the CPU 301 determines whether or not data to be output from the image processing apparatus 120 is data that can be set as configuration information for the image processing apparatus 110. It should be noted that this determination is made based on information contained in the received response (such as a file extension of the body data, or information present at the head of the body data), for example.

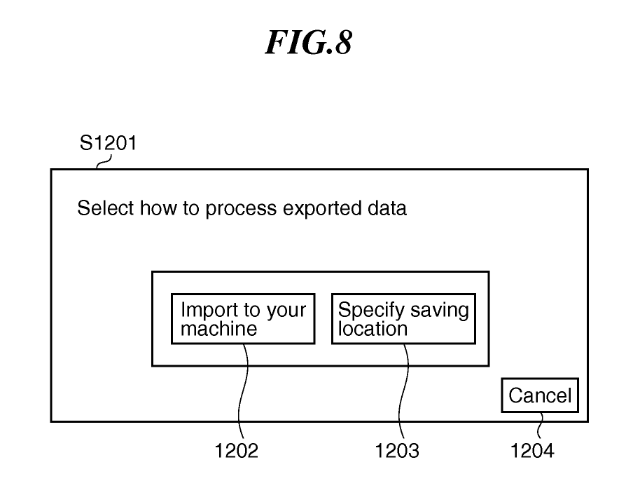

If the CPU 301 determines that the data is the importable configuration information data, the CPU 301 proceeds to step S1304 to create screen information for displaying an operation screen such as shown in FIG. 8, and outputs the information to the LCD display section 501 via the output port 602. As a result, display 1201 characteristic to the present embodiment as shown in FIG. 8, that is, a screen for selecting how to process data, is displayed on the LCD display section 501.

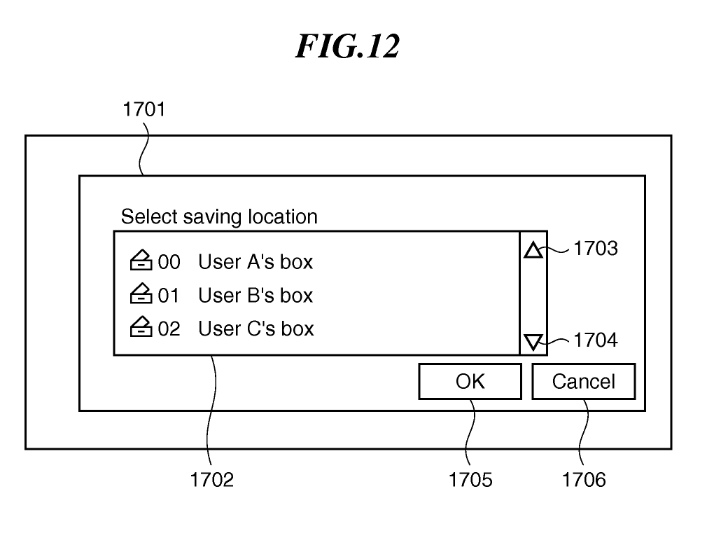

If the CPU 301 determines that the data cannot be imported in step S1303, the CPU 301 displays a normal save dialogue shown in FIG. 12 (step S1307) or saves the data in the temporary area of the HDD 304 which is specified as the default location for the apparatus.

On the screen shown in FIG. 8, “Import to your machine” button 1202 is a button for the user to order the execution of a process for analyzing configuration information output from the image processing apparatus 120 and setting the information as the configuration information for the user's own apparatus (i.e., device information loading process). “Specify saving location” button 1203 is a button for ordering execution of a process for saving the configuration information output from the image processing apparatus 120 in a storage section in the image processing apparatus 110 without setting it as configuration information for the image processing apparatus 110.

If the “Import to your machine” button 1202 is pressed on the screen of FIG. 8, the CPU 301 proceeds to step S1306 to automatically store the configuration information output from the image processing apparatus 120 in the temporary area of the HDD 304 and terminates the HTTP session.

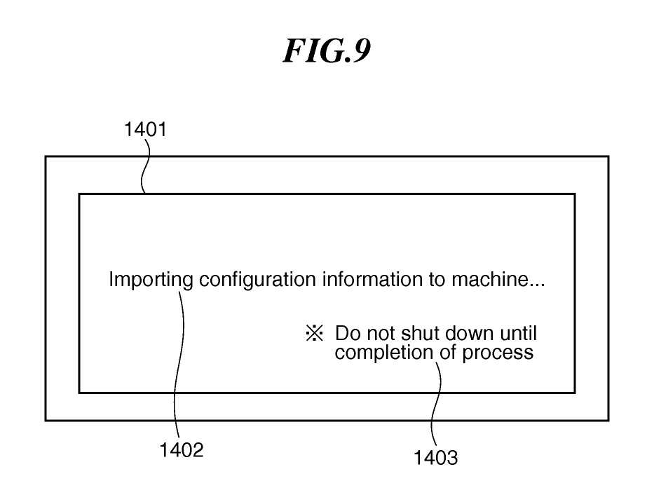

FIG. 9 shows an example of a dialogue window which is displayed on the LCD display section 501 in accordance with a configuration information loading process executed by the image processing apparatus 110 when the “Import to your machine” button 1202 is pressed on the display 1201.

In a dialogue window 1401, a status message 1402 and a caution message 1403 are displayed. The status message 1402 indicates that a configuration information import process is in progress. The caution message 1403 shows an operation prohibited during progress of the process. When an import process is completed, the dialogue window disappears and a screen (not shown) preceding the display of the screen of FIG. 8 appears again. An import stop button may be provided on the display 1401 and pressing of the button also brings back the screen preceding the display of the screen shown in FIG. 8.

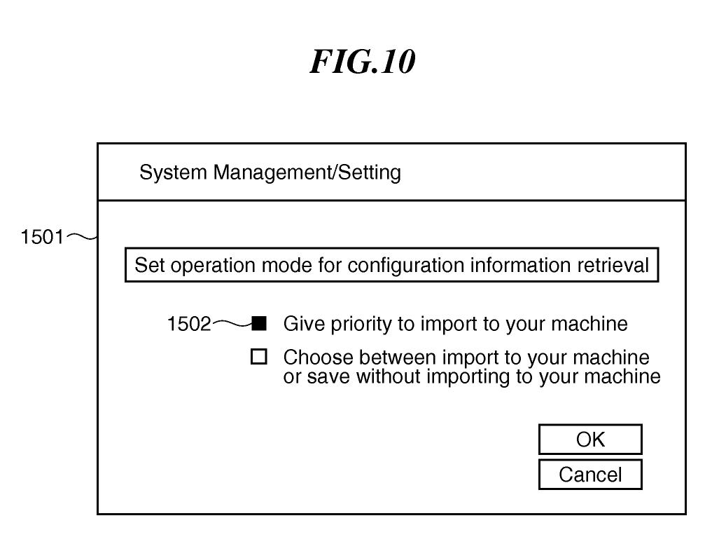

The present embodiment also allows the user to specify an operation mode to give higher priority when configuration information is received. Specifically, on screen display 1501 for system management/setting shown in FIG. 10, if the user selects “Give priority to import to your machine” shown on display 1502, the CPU 301 skips a selection process conducted on the screen shown in FIG. 8 (a first mode) and automatically performs setting of the configuration information (a second mode). This can further improve convenience for a user who primarily wants to set configuration information onto his apparatus. If the user selects “Choose between import to your machine or save without importing to your machine” on the display 1501, the screen shown in FIG. 8 will be displayed.

(C) Device Information Importing Process

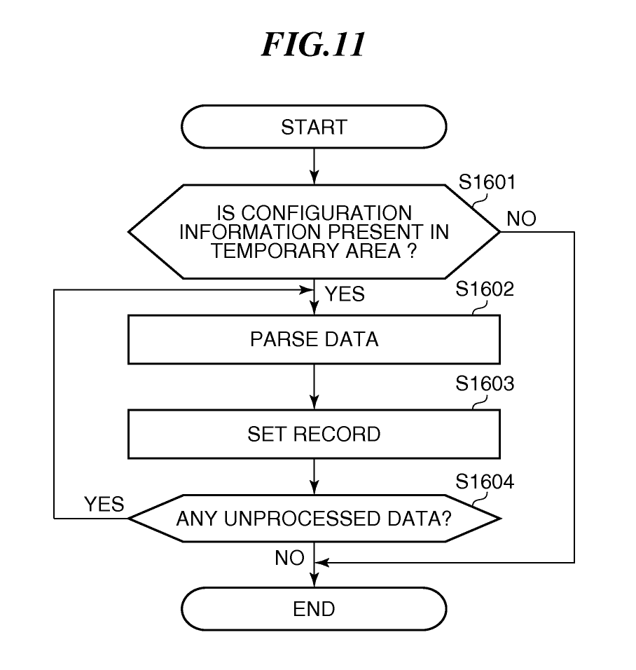

Next, a process of the CPU 301 importing configuration information stored in the temporary area will be described with reference to FIG. 11.

FIG. 11 is a flowchart showing a flow of the process for importing configuration information by the CPU 301 of the image processing apparatus 110.

The CPU 301 first checks in step S1601 whether configuration information data is present in the temporary area of the HDD 304. If data is present, the CPU 301 parses the data until the CPU 301 obtains one record that can be set or registered into the apparatus in step S1602. Upon obtaining one record that can be set or registered into the apparatus, the CPU 301 sets or registers the record as configuration information of the apparatus 110 (step S1603).

The CPU 301 repetitively performs the process in steps S1602 and S1603 up to the end of the data and terminates processing. If data is not present in step S1601, the CPU 301 terminates the process without processing any data. Here, an indication that no data is present (not shown) may be provided on the LCD display section 501.

FIG. 12 shows an example of a dialogue window that is displayed on the LCD display section 501 in step S1307 when the “Specify saving location” button 1203 is pressed on the display 1201 of FIG. 8. When the button 1203 on the display of FIG. 8, that is, the “Specify saving location” button, is pressed, a dialogue window 1701 appears as shown in FIG. 12. The dialogue window 1701 shows a box selection field 1702, scroll buttons 1703, 1704, and buttons 1705, 1706.

Each row of the box selection field 1702 shows information for one box (a box number, and a box name of the box). When the scroll button 1703 or 1704 is pressed, the range of boxes being displayed in the box selection field is changed. When a certain row is selected, the button 1705 is highlighted and becomes available. If the button 1705 is pressed here, configuration information data output from the image processing apparatus 120 is saved in a specified box. The button 1706 is a cancel button for quitting the process and returning to the screen of FIG. 8.

Thus, even when body data output from the web server is determined to be configuration information that can be imported to the image processing apparatus 110, the received configuration information can be saved in a storage section without being set on the image processing apparatus 110. This can meet such a need of the user as to temporarily use the received configuration information as necessary without setting it as configuration information of the image processing apparatus 110 immediately after its reception, for example. Alternatively, if body data output from the web server is determined to be importable configuration information but actually is not information suitable for setting as configuration information for the image processing apparatus 110 in terms of contents, the information can be once saved and then edited to be set as configuration information.

As described, according to the present embodiment, automated import of configuration information to an apparatus by a simple operational procedure without having to specially implementing the server side that outputs the configuration information can be realized. That is to say, it eliminates the necessity to give setting instructions for the user to retrieve and save configuration information of another apparatus in advance and then set the information as configuration information of his own apparatus when loading the configuration information of another apparatus to his apparatus. It is therefore possible to provide the user with a way of automated exchange and setting of configuration information through a small number of simple operations and hence improve the user's convenience.

In addition, especially by switching between display and non-display of the “Import to your machine” button 1202 based on the result of determination of whether configuration information is importable to the image processing apparatus 110, the present embodiment also provides the following advantage: it is possible to avoid confusing the user with display of the “Import to your machine” button 1202 which is unnecessary when configuration information not importable to the image processing apparatus 110 is output from the web server.

Although the present embodiment assumes that a saving location that can be specified by a user is a box for the sake of simplicity, the specifiable saving location may also be a portable medium like a connected USB memory or a file server on a network.

Also, although the present embodiment assumes that a server for outputting configuration information is a web server included in the image processing apparatus 120, similar effects can be obtained when the outputting server is a web server at a service center or a web server that provides a web site for product support.

Next, a second embodiment of the present invention is described.

In the above-described first embodiment, the client side (i.e., the web browser) that receives configuration information creates a characteristic screen as shown in FIG. 8; whereas the second embodiment shows a case where a web server side that sends configuration information creates data for the characteristic screen.

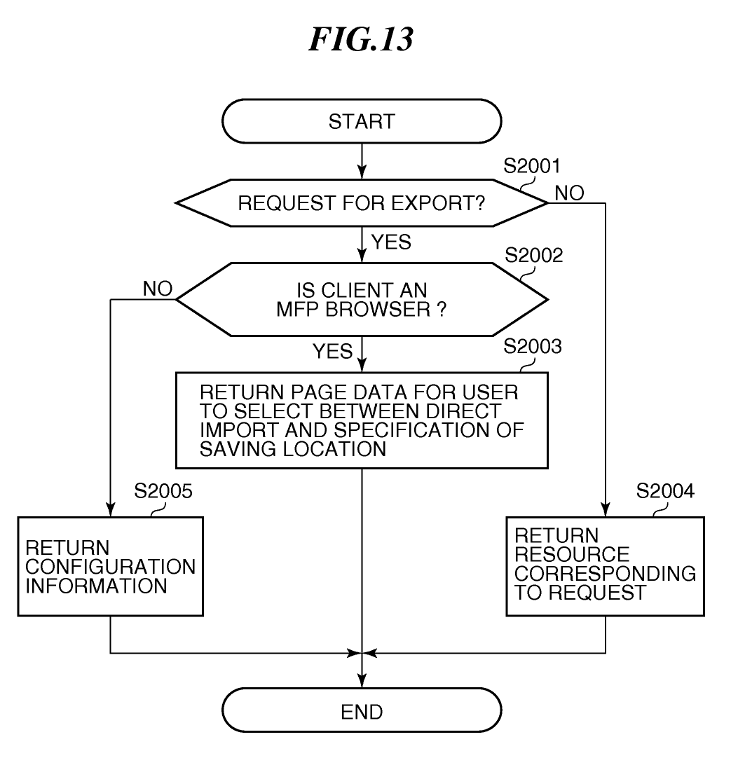

FIG. 13 is a flowchart showing operations according to the second embodiment, and showing processing procedures performed by the web server of the image processing apparatus 120.

First in step S2001, the web server of the image processing apparatus 120 determines whether an HTTP request accepted from the image processing apparatus 110 as a client is a request for outputting information stored in the image processing apparatus 120 or not. If the HTTP request is such a request, the web server proceeds to step S2002 to determine whether the client that issued the request is an agent of the image processing apparatus 110 or not. This determination may be made based on a value in User-Agent field of the HTTP request, for example.

If the web server determines that the client is an agent of the image processing apparatus 110, the web server proceeds to step S2003. In step S2003, the web server creates data for a page that asks the user to select either a setting process for setting configuration information to be output as configuration information of the image processing apparatus 110, which is the client, or a saving process for saving the configuration information in a storage section of the image processing apparatus 110. The web server then returns the page data to the client.

Thereafter, the page data is appropriately processed by the web browser 211 of the image processing apparatus 110 as the client, causing such a screen as shown in FIG. 8 to be displayed in the content display area 905 of the image processing apparatus 110.

If the HTTP request is not a request for outputting information stored in the image processing apparatus in step S2001, the web server selects an HTML resource corresponding to the request from a file system in the server or creates data, and sends the resource or data to the client (step S2004).

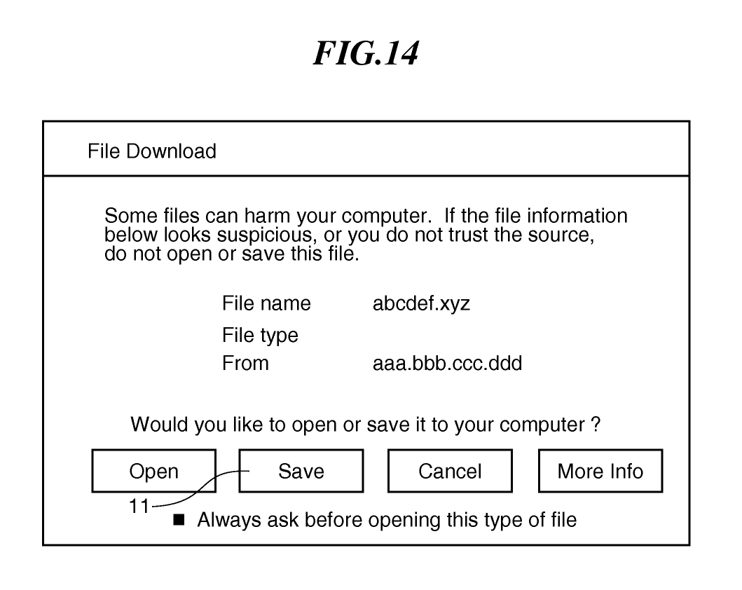

If the client is not an agent of the image processing apparatus 110 but an agent of a PC, for example, the web server sends configuration information appropriate for the request (step S2005). At this point, such a save dialogue as shown in FIG. 14 is displayed on the web browser of the PC in accordance with settings of the browser.

According to the present embodiment, the user's convenience is improved because the user can automatically exchange and set configuration information with a small number of simple operations without having to retrieve and prepare configuration information beforehand when loading configuration information of another apparatus into his apparatus.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority the benefit of Japanese Patent Application No. 2009-035400 filed Feb. 18, 2009, which is hereby incorporated by reference herein in its entirety.

What is claimed is:

1. An image processing apparatus that performs communication with an external apparatus connected via a network based on a predetermined communication protocol, the image processing apparatus comprising:
a request unit adapted to request the external apparatus to output information stored in the external apparatus;
a determination unit adapted to determine whether or not information to be output from the external apparatus is information that can be set as configuration information for the image processing apparatus, based on a response from the external apparatus to the request from said request unit; and
a presentation unit adapted to present a user with a setup ordering button for the user to order setting of information output from the external apparatus as configuration information for the image processing apparatus if said determination unit determines that the information to be output from the external apparatus is information that can be set as configuration information for the image processing apparatus.

2. The image processing apparatus according to claim 1, further comprising a setup unit adapted to receive the information from the external apparatus and set the received information as configuration information for the image processing apparatus if the user orders setting of the information output from the external apparatus as configuration information for the image processing apparatus using said setup ordering button.

3. The image processing apparatus according to claim 1, wherein said presentation unit displays an operation screen including the setup ordering button on a display section of the image processing apparatus.

4. The image processing apparatus according to claim 3, wherein the operation screen further includes a save ordering button for the user to order saving of information output from the external apparatus in a storage section of the image processing apparatus without setting the information as configuration information for the image processing apparatus.

5. The image processing apparatus according to claim 2, further comprising
a selection unit adapted to select either a first mode or a second mode as an operation mode of the image processing apparatus, wherein
if said determination unit determines that the information to be output from the external apparatus is information that can be set as configuration information for the image processing apparatus, said presentation unit presents the setup ordering button when the first mode is selected by said selection unit, or said setup unit performs the setting without said presentation unit presenting the setup ordering button when the second mode is selected by said selection unit.

6. The image processing apparatus according to claim 1, further comprising a web browser, wherein
said request unit requests output of the information in accordance with an instruction entered via a screen which is displayed by said web browser based on an HTML file provided by the external apparatus.

7. A server apparatus that performs communication with a client apparatus connected via a network based on a predetermined communication protocol, the server apparatus comprising:
an acceptance unit adapted to accept an output request for information stored in the server apparatus from the client apparatus;
a determination unit adapted to, if said acceptance unit accepts the output request for information, determine whether or not a client apparatus that made the output request is a particular client apparatus; and
a transmission unit adapted to transmit, to the client apparatus, screen information for displaying an operation screen including a setup ordering button for a user to order setting of information output by the server apparatus as configuration information for the client apparatus on a display section of the client apparatus if said determination unit determines that the client apparatus that made the output request is a particular client apparatus.

8. The server apparatus according to claim 7, wherein the operation screen further includes a save ordering button for the user to order saving of information output from the server apparatus in a storage section of the client apparatus without setting the information as configuration information for the client apparatus.

9. The server apparatus according to claim 7, further comprising a web server, wherein
said transmission unit transmits an HTML file as the screen information for displaying the operation screen on a web browser of the client apparatus.

10. A control method for an image processing apparatus that performs communication with an external apparatus connected via a network based on a predetermined communication protocol, the method comprising:
a request step of requesting said external apparatus to output information stored in the external apparatus;
a determination step of determining whether or not information to be output from the external apparatus is information that can be set as configuration information for the image processing apparatus, based on a response from the external apparatus to the request made in said request step; and
a presentation step of presenting a user with a setup ordering button for the user to order setting of information output from the external apparatus as configuration information for the image processing apparatus if said determination step determines that the information to be output from said external apparatus is information that can be set as configuration information for said image processing apparatus.

11. A control method for a server apparatus that performs communication with a client apparatus connected via a network based on a predetermined communication protocol, the method comprising:
an acceptance step of accepting an output request for information stored in the server apparatus from the client apparatus;
a determination step of, if the output request for information is accepted in said acceptance step, determining whether or not a client apparatus that made the output request is a particular client apparatus; and
a transmission step of transmitting, to the client apparatus, screen information for displaying an operation screen including a setup ordering button for a user to order setting of information output by the server apparatus as configuration information for the client apparatus on a display section of the client apparatus if said determination step determines that the client apparatus that made the output request is a particular client apparatus.

12. A computer-readable storage medium for storing a program for causing a computer to implement a control method for an image processing apparatus according to claim 10.

13. A computer-readable storage medium for storing a program for causing a computer to implement a control method for a server apparatus according to claim 11.
